(19) United States
(12) Patent Application Publication
(10) Pub. No.: US 2026/0064026 A1
(43) Pub. Date: Mar. 5, 2026

(54) IMAGE FORMING SYSTEM

(71) Applicant: FUJIFILM Business Innovation Corp., Tokyo (JP)

(72) Inventor: Naoya MITAMURA, Kanagawa (JP)

(73) Assignee: FUJIFILM Business Innovation Corp., Tokyo (JP)

(21) Appl. No.: 19/042,973

(22) Filed: Jan. 31, 2025

(30) Foreign Application Priority Data
Sep. 4, 2024 (JP) 2024-152718

(51) Int. Cl. G03G 15/02; G03G 15/00

(52) U.S. Cl. CPC G03G 15/0266; G03G 15/0225; G03G 15/5008; G03G 15/5041; G03G 15/5054; G03G 2215/00059

(57) ABSTRACT

An image forming system includes an image carrier that rotates, a charging unit that rotates while being in contact with the image carrier and charges a surface of the image carrier by applying a charging bias, a pressing member that presses the charging unit against the image carrier such that a nip width is generated, a developing unit that develops a latent image formed on the surface of the image carrier with toner, and at least one processor, in which the processor is configured to, in a state in which an absolute value of a surface potential of the image carrier charged by the charging unit is lower than an absolute value of a developing potential of the developing unit, increase an absolute value of a potential of the charging unit with a rectangular wave only for a set time during which instantaneous discharge occurs before and after the nip width of the charging unit to the image carrier and no discharge occurs at a center of the nip width such that the absolute value of the surface potential of the image carrier is higher than the absolute value of the developing potential.

### CROSS-REFERENCE TO RELATED APPLICATIONS

This application is based on and claims priority under 35 USC 119 from Japanese Patent Application No. 2024-152718 filed Sep. 4, 2024

### BACKGROUND

### (i) Technical Field

The present disclosure relates to an image forming system.

### (ii) Related Art

JP2002-268296A discloses an image forming apparatus including a charging member, a latent image forming unit, a developing unit, and a light sensor. The charging member is disposed in contact with or close to a photoreceptor. The latent image forming unit forms an electrostatic latent image on the photoreceptor charged by the charging member. The developing unit adheres toner to the electrostatic latent image and visualizes the image. A voltage applying unit applies a voltage to the charging member. The light sensor detects a reflection density of the surface of the photoreceptor. In the image forming apparatus, the voltage applied to the charging member can be changed, and the applied voltage output from the voltage applying unit can be changed according to an output ratio of the light sensor before and after the change. Further, in the image forming apparatus, the light sensor is configured to serve as a toner density sensor, and the light sensor is installed in a longitudinal direction of the photoreceptor between a development width end portion and a position corresponding to the toner density sensor.

### SUMMARY

Aspects of non-limiting embodiments of the present disclosure relate to an image forming system that is capable of estimating a nip width of a charging unit to an image carrier.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an image forming system including an image carrier that rotates, a charging unit that rotates while being in contact with the image carrier and charges a surface of the image carrier by applying a charging bias, a pressing member that presses the charging unit against the image carrier such that a nip width is generated, a developing unit that develops a latent image formed on the surface of the image carrier with toner, and at least one processor, in which the processor is configured to, in a state in which an absolute value of a surface potential of the image carrier charged by the charging unit is lower than an absolute value of a developing potential of the developing unit, increase an absolute value of a potential of the charging unit with a rectangular wave only for a set time during which instantaneous discharge occurs before and after the nip width of the charging unit to the image carrier and no discharge occurs at a center of the nip width such that the absolute value of the surface potential of the image carrier is higher than the absolute value of the developing potential.

### BRIEF DESCRIPTION OF THE DRAWINGS

Exemplary embodiment(s) of the present invention will be described in detail based on the following figures, wherein:

FIG. 1 is a schematic configuration view showing an image forming system according to a first exemplary embodiment;

FIG. 2 is a side view showing a charging roll and a vicinity of a photoreceptor of the image forming system according to the first exemplary embodiment;

FIG. 3 is a cross-sectional view showing a nip width of the charging roll to the photoreceptor in the image forming system according to the first exemplary embodiment;

FIG. 4 is a graph showing a relationship between an axial position of the charging roll and a nip width;

FIG. 5 is a graph showing a relationship between a nip width of a charging roll to a photoreceptor and an amount of an external additive adhering to the charging roll;

FIG. 6 is a block diagram showing a hardware configuration of the image forming system according to the first exemplary embodiment;

FIG. 7 is an explanatory diagram showing potential of each unit, developing toner, and output of a density sensor with respect to time when detecting a nip width of the charging roll to the photoreceptor;

FIG. 8 is an explanatory diagram showing a state of discharge in a case where a photoreceptor is charged by the charging roll;

FIG. 9A is an explanatory diagram showing a state of the charging roll, an exposure device, and a primary transfer roll at a time of normal image formation, and FIG. 9B is an explanatory diagram showing a state of the charging roll and the photoreceptor at the time of normal image formation;

FIG. 10A is an explanatory diagram showing a state of the charging roll, the exposure device, and the primary transfer roll in a case of cleaning of the charging roll, and FIG. 10B is an explanatory diagram showing a state of the charging roll and the photoreceptor in a case of cleaning of the charging roll;

FIG. 11 is a flowchart showing a flow of information processing of the image forming system according to the first exemplary embodiment; and

FIG. 12 is a schematic configuration view showing a toner image forming unit of the image forming system according to a second exemplary embodiment.

### DETAILED DESCRIPTION

Exemplary embodiments of the present invention will be described below. In the following description, a direction indicated by an arrow H in each drawing is a vertical direction and is a device height direction, and a direction indicated by an arrow W is a horizontal direction and is a device width direction. In each drawing, a direction orthogonal to each of the device height direction and the device width direction (a direction of an arrow D) is set as a device depth direction.

### First Exemplary Embodiment

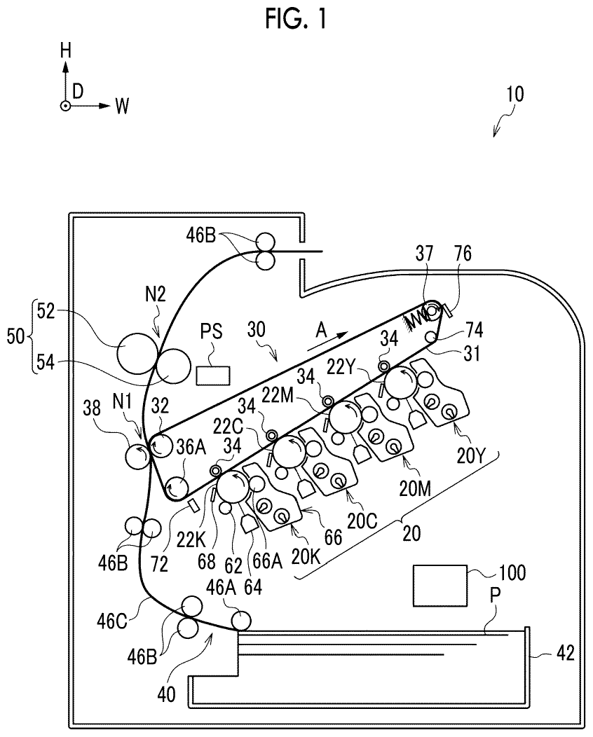

FIG. 1 is a front view showing an overall configuration of an image forming system 10 of the first exemplary embodiment. In the first exemplary embodiment, first, the overall configuration of the image forming system 10 will be described, and then content related to a nip width of a charging roll to a photoreceptor will be described.

### Overall Configuration of Image Forming System

As shown in FIG. 1, the image forming system 10 of the first exemplary embodiment is an electrophotographic device including a toner image forming unit 20, a transfer device 30, a transport device 40, a fixing device 50, and a control unit 100. In the following, the overall configuration of the image forming system 10 will be described with reference to FIG. 1 unless otherwise specified.

### Toner Image Forming Unit

The toner image forming unit 20 has a function of forming toner images on photoreceptors 22Y, 22M, 22C, and 22K by performing each of the charging, exposure, and developing steps. The toner image forming unit 20 includes monochrome units 20Y, 20M, 20C, and 20K of yellow, magenta, cyan, and black. Further, the monochrome units 20Y, 20M, 20C, and 20K each include the photoreceptors 22Y, 22M, 22C, and 22K. The photoreceptors 22Y, 22M, 22C, and 22K are examples of image carriers. In a case where the image forming system 10 is viewed from the front side as shown in FIG. 1, the monochrome units 20Y, 20M, 20C, and 20K are arranged in the order from right to left in the device width direction (below a transfer belt 31). In addition, polarity of an average charge amount of the toner used in the first exemplary embodiment is, for example, negative.

In the monochrome units 20Y, 20M, 20C, and 20K, the respective configuration members are the same except for the color of the toner. Therefore, in a case where it is not necessary to distinguish the color of the toner, the reference numerals Y, M, C, and K after each member may be omitted. Each of the monochrome units 20Y, 20M, 20C, and 20K has a charging roll 62, an exposure device 64, a developing device 66, and a cleaning blade 68 around the photoreceptor 22 that rotates in a direction indicated by an arrow. The charging roll 62 is an example of a charging unit. The charging roll 62 rotates while being in contact with the photoreceptor 22, and charges the photoreceptor 22 by applying a charging bias. The exposure device 64 exposes the photoreceptor 22 charged by the charging roll 62 and forms a latent image on the photoreceptor 22. The developing device 66 includes a developing roll 66A that develops the latent image formed on the photoreceptor 22 by the exposure device 64 with toner. The cleaning blade 68 removes the toner remaining on the surface of the photoreceptor 22 after the toner image is transferred to the transfer device 30. The developing device 66 is an example of a developing unit. The cleaning blade 68 is an example of a cleaning member.

The charging roll 62 charges, for example, the surface (photosensitive layer) of the photoreceptor 22 in a negative polarity. The surface of the photoreceptor 22 charged in a negative polarity has a positive polarity in a portion irradiated with the exposure light by the exposure device 64, and a latent image is formed on the surface of the photoreceptor 22. Then, the toner that has been charged by friction in a negative polarity in the developing device 66 adheres to the latent image having a positive polarity, and the latent image is developed. As a result, a toner image is formed on the surface of the photoreceptor 22.

As an example, the charging roll 62 is a circular rotating body. The charging roll 62 is driven to rotate with the rotation of the photoreceptor 22. As an example, the charging bias in which an AC voltage is added to a DC voltage is applied to the charging roll 62. The charging roll 62 charges the photoreceptor 22 by adding the AC voltage to the DC voltage.

The cleaning blade 68 is disposed on a downstream side of a primary transfer position where the toner image on the surface of the photoreceptor 22 is transferred onto the transfer belt 31 and on an upstream side of the charging roll 62.

### Transfer Device

The transfer device 30 has a function of primarily transferring the toner images formed on the respective photoreceptors 22Y, 22M, 22C, and 22K to the transfer belt 31. Further, the transfer device 30 has a function of secondarily transferring the toner image held on the transfer belt 31 to a medium P. The medium Pis an example of a recording medium, and for example, is paper.

As shown in FIG. 1, the transfer device 30 includes the transfer belt 31, a drive roll 32, a plurality of primary transfer rolls 34, a driven roll 36, and a tension roll 37. Further, the transfer device 30 includes a secondary transfer roll 38, a density sensor 72, a support roll 74, and a cleaning blade 76. Here, the transfer belt 31 is an example of an intermediate transfer body, and the density sensor 72 is an example of a density detection unit.

The transfer belt 31 is endless, is wound around the drive roll 32 that rotates around an axis, and is driven by the drive roll 32 to circulate in a circumferential direction (an arrow A direction). That is, the transfer belt 31 has a function of holding the toner image and transporting the toner image in the circumferential direction (the arrow A direction). The transfer belt 31 holds the toner images that have been primarily transferred by the primary transfer rolls 34 from the photoreceptors 22Y, 22M, 22C, and 22K on which the toner images of the respective colors have been formed.

In addition, as shown in FIG. 1, in a case where the image forming system 10 is viewed from the front side, the driven roll 36 is disposed below the drive roll 32, and the tension roll 37 is disposed above the drive roll 32 and on the right side in the device width direction. Further, the support roll 74 is disposed below the tension roll 37. The transfer belt 31 is wound around the drive roll 32, the driven roll 36, the tension roll 37, and the support roll 74, and a posture of the transfer belt 31 is determined.

### Primary Transfer Roll

The primary transfer roll 34 has a function of transferring the toner images held by the photoreceptors 22Y, 22M, 22C, and 22K to the transfer belt 31 by applying a transfer voltage. The primary transfer roll 34 is in contact with an inner surface of the transfer belt 31 and rotates around an axis.

### Secondary Transfer Roll

The secondary transfer roll 38 has a function of transferring the toner image onto the medium P by sandwiching the medium P between the secondary transfer roll 38 and a part of the transfer belt 31 wound around the drive roll 32. The secondary transfer roll 38 is disposed on the opposite side of the drive roll 32 sandwiching the transfer belt 31, and forms a nip N1 on the transfer belt 31 with the drive roll 32.

The secondary transfer roll 38 rotates around an axis, and the transfer voltage is applied to the drive roll 32 from a power supply PS (refer to FIG. 1). As a result, the secondary transfer roll 38 and the drive roll 32 transfer the toner image held by the transfer belt 31 to the medium P passing through the nip N1. The secondary transfer roll 38 is grounded.

### Tension Roll

The tension roll 37 has a function of applying tension (that is, tension) to the transfer belt 31. The tension roll 37 is driven to rotate in accordance with the movement of the transfer belt 31 in the circumferential direction (the arrow A direction). An outer peripheral surface of the tension roll 37 is pressed against an inner surface of the transfer belt 31, and thus tension is applied to the transfer belt 31. As a result, the transfer belt 31 moves in the circumferential direction (the arrow A direction) in a state in which the tension is applied thereto, and transports the toner image held on the surface.

### Support Roll

The support roll 74 has a function of supporting the transfer belt 31 by coming into contact with the inner surface of the transfer belt 31. The support roll 74 is driven in accordance with the circulating movement of the transfer belt 31.

### Density Sensor

The density sensor 72 has a function of measuring the density of the toner image transferred onto the surface of the transfer belt 31 by irradiating the transfer belt 31 with light and detecting the light reflected by the transfer belt 31. The density sensor 72 is disposed to face a position on the outer periphery of the transfer belt 31, which is on the downstream side in the circumferential direction of the transfer belt 31 with respect to the toner image forming unit 20 and on the upstream side with respect to the driven roll 36.

As an example, the density sensors 72 are provided at each of both end portions in the width direction, which intersects the movement direction (the arrow A direction) of the transfer belt 31. In a case where the density sensor 72 measures the toner density on the surface of the transfer belt 31, the density sensor 72 irradiates the transfer belt 31 with light and detects the light reflected by the transfer belt 31. The output of the density sensor 72 is input to a control unit 100 (refer to FIG. 1).

### Cleaning Blade

The cleaning blade 76 has a function of coming into contact with the surface of the transfer belt 31 and cleaning the surface of the transfer belt 31. The cleaning blade 76 is disposed on a downstream side of the transfer position of the secondary transfer roll 38 in the circumferential direction (the arrow A direction) of the transfer belt 31. A tip end portion of the cleaning blade 76 comes into contact with the surface of the transfer belt 31, and thus the cleaning blade 76 removes an adhesive substance such as toner remaining on the surface of the transfer belt 31 after the toner image has been secondarily transferred.

### Transport Device

The transport device 40 has a function of transporting the medium P accommodated in a medium accommodation unit 42 through a transport path 46C including the nip N1 and a nip N2 and discharging the medium P to the outside of the housing of the image forming system 10. The transport device 40 includes a feeding roll 46A and a plurality of transport roll pairs 46B.

### Fixing Device

The fixing device 50 has a function of fixing the toner image transferred onto the medium P by the transfer device 30 to the medium P. The fixing device 50 includes a heating roll 54 and a pressurizing roll 52. The fixing device 50 heats the medium P passing through the nip N2, which is formed by the heating roll 54 and the pressurizing roll 52, with the heating roll 54 and pressurizes the medium P with the heating roll 54 and the pressurizing roll 52. As a result, the toner image is fixed to the medium P.

### Control Unit

The control unit 100 has a function of controlling each of the components of the image forming system 10. The control unit 100 will be described later.

### Operation of Image Forming System

Next, the operation of the image forming system 10 will be described.

In a case where the operation of the image forming system 10 is started, the monochrome units 20Y, 20M, 20C, and 20K of the toner image forming unit 20 form toner images of each color on the surfaces of the photoreceptors 22Y, 22M, 22C, and 22K by the charging, exposure, and developing steps. Specifically, the charging roll 62 charges the photoreceptor 22, and the exposure device 64 exposes the photoreceptor 22, so that a latent image is formed on the surface of the photoreceptor 22. Further, the latent image of the photoreceptor 22 is developed with the toner by the developing device 66. As a result, in the monochrome units 20Y, 20M, 20C, and 20K, the toner images of each color are formed on the surfaces of the photoreceptors 22Y, 22M, 22C, and 22K.

In the image forming system 10, a primary transfer voltage is applied to the primary transfer roll 34 of each color. In addition, the drive roll 32 causes the transfer belt 31 to circulate in the arrow A direction. As a result, the toner images of each color formed on the photoreceptors 22Y, 22M, 22C, and 22K are primarily transferred onto the transfer belt 31 in a superimposed manner.

On the other hand, the transport device 40 transports the medium P accommodated in the medium accommodation unit 42 to the nip N1 so as to coincide with the timing at which the portion where the toner images of each color on the transfer belt 31 is primarily transferred reaches the nip N1. Then, by applying a transfer voltage to the drive roll 32, an electric field is formed between the drive roll 32 and the secondary transfer roll 38, and the toner images of each color held by the transfer belt 31 are transferred onto the medium P.

Further, the transport device 40 transports the medium P, onto which the toner images of each color are transferred, toward the nip N2 of the fixing device 50. Then, the fixing device 50 fixes the toner images of each color to the medium P passing through the nip N2, and forms an image on the medium P.

The medium P on which the image is formed is discharged to the outside of the device by the transport device 40. Accordingly, the image forming operation is ended.

### Nip Width of Charging Roll

Next, the nip width of the charging roll 62 to the photoreceptor 22 will be described.

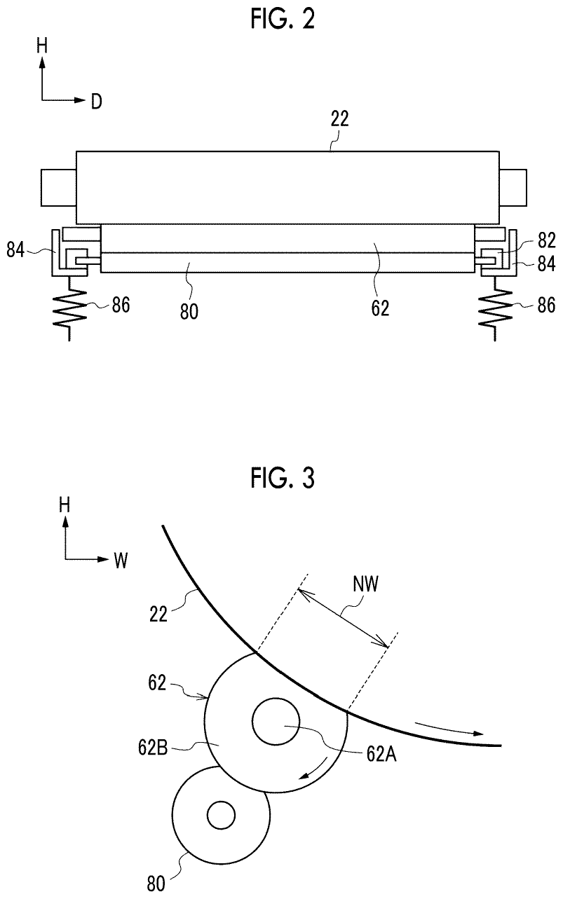

FIG. 2 is a side view of the configuration in the vicinity of the charging roll 62, and FIG. 3 is a cross-sectional view of the configuration in the vicinity of the charging roll 62.

As shown in FIG. 2 and FIG. 3, the charging roll 62 is disposed along the axial direction of the photoreceptor 22, and the charging roll 62 is in contact with the photoreceptor 22. A cleaning roll 80 that removes an adhesive substance on the surface of the charging roll 62 is disposed on the opposite side of the charging roll 62 with respect to the photoreceptor 22. The cleaning roll 80 is disposed along the axial direction of the charging roll 62, and the cleaning roll 80 is in contact with the charging roll 62. A holding unit 82 that holds a shaft portion of the cleaning roll 80 to be rotatable is provided at both end portions of the cleaning roll 80 in the axial direction (refer to FIG. 2). In FIG. 2, a holding unit that holds a shaft portion 62A of the charging roll 62 to be rotatable and a holding unit that holds the shaft portion of the photoreceptor 22 to be rotatable are not shown.

As shown in FIG. 2, as an example, the holding unit 82 is supported by a support frame 84 having a substantially L-shape that is symmetrical with respect to the right and left. The support frame 84 is pressed against a photoreceptor 22 side by a coil spring 86. The coil spring 86 is an example of a pressing member. The coil spring 86 presses the charging roll 62 against the photoreceptor 22 such that a nip width NW is generated (refer to FIG. 3). Here, the nip width NW is a width where the charging roll 62 is in contact with the photoreceptor 22 in the rotation direction (arrow direction) of the photoreceptor 22. As an example, the charging roll 62 includes the shaft portion 62A and an elastic layer 62B that is formed around the shaft portion 62A and has conductivity. The charging roll 62 is pressed against the photoreceptor 22, so that the nip width NW of the charging roll 62 is generated. The coil spring 86 is provided at both end portions of the cleaning roll 80 in the axial direction. As an example, by the coil spring 86, the charging roll 62 is pressed against the photoreceptor 22 via the cleaning roll 80.

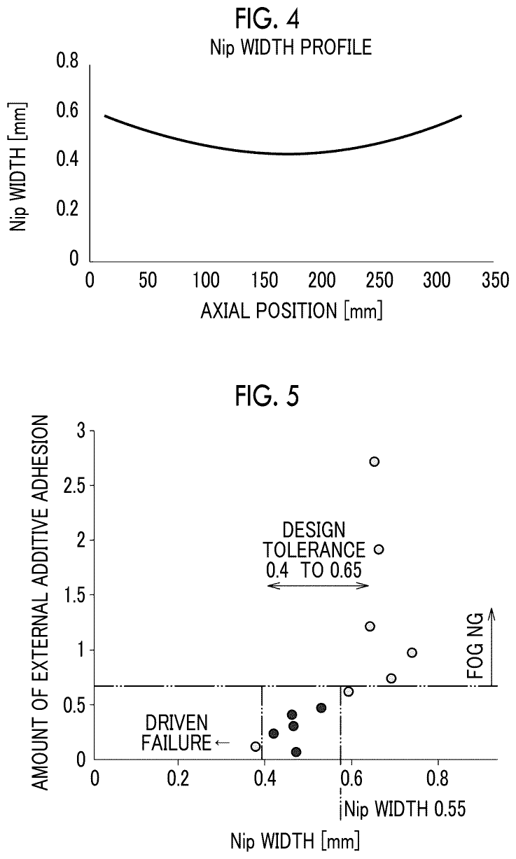

FIG. 4 is a graph showing a profile of a nip width (Nip width) NW of the charging roll 62 to the photoreceptor 22. In FIG. 4, a relationship between an axial position of the charging roll 62 and the nip width NW is shown. Both end portions of the charging roll 62 in the axial direction are pressed against the photoreceptor 22 by the coil spring 86 (refer to FIG. 2). Therefore, as shown in FIG. 4, the nip width NW of the both end portions of the charging roll 62 in the axial direction is larger than the nip width NW of a central portion in the axial direction.

FIG. 5 is a graph showing a relationship between the nip width NW and an amount of an external additive adhering to the charging roll 62. Developer contains the external additive. As shown in FIG. 5, in a case where the nip width NW of the charging roll 62 to the photoreceptor 22 increases, the external additive is likely to adhere to the charging roll 62. In a case where the nip width NW of the charging roll 62 to the photoreceptor 22 is, for example, 0.39 [mm] or less, the charging roll 62 is likely to be driven to rotate poorly in a case where the charging roll 62 is driven to rotate by the rotation of the photoreceptor 22. In addition, in a case where the amount of the external additive adhering to the charging roll 62 is, for example, 0.7 [mg] or more, the charging roll 62 is likely to cause the charging failure of the photoreceptor 22, and thus the fog toner is likely to occur on the photoreceptor 22. In the present example, in a case where the nip width NW of the charging roll 62 to the photoreceptor 22 is, for example, 0.55 [mm] or more, the amount of the external additive adhering to the charging roll 62 increases. In this case, it is easy to occur the fog toner on the photoreceptor 22 because of the charging failure of the photoreceptor 22 due to the charging roll 62. Therefore, in a case where the nip width NW of the charging roll 62 to the photoreceptor 22 is, for example, 0.55 [mm] or more, it is desirable to remove the adhesive substance such as the external additives adhering to the charging roll 62.

### Hardware Configuration of Image Forming System

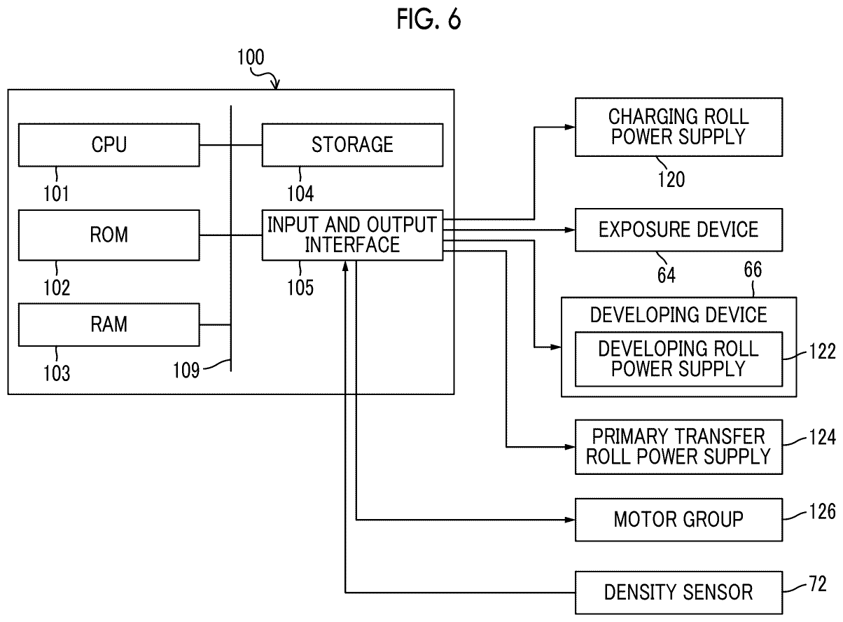

FIG. 6 is a block diagram showing a hardware configuration of the image forming system 10. In FIG. 6, a hardware configuration not related to the major part of the present disclosure is omitted.

As shown in FIG. 6, the image forming system 10 includes a control unit 100, a charging roll power supply 120, the exposure device 64, the developing device 66, a primary transfer roll power supply 124, a motor group 126, and a density sensor 72. The developing device 66 includes a developing roll power supply 122. Further, the motor group 126 drives rolls of each unit of the image forming system 10.

The control unit 100 has each configuration of a central processing unit (CPU) 101, a read only memory (ROM) 102, a random access memory (RAM) 103, a storage 104, and an input and output interface 105. The configurations are communicably connected to each other via a bus 109.

The CPU 101 is a central arithmetic processing unit that executes various programs and controls each unit. The CPU 101 is an example of a processor. That is, the CPU 101 reads out a program from the ROM 102 or the storage 104, and executes the program using the RAM 103 as a working area. The CPU 101 controls each of the above-described configurations and performs various types of arithmetic processes according to the program recorded on the ROM 102 or the storage 104. In the first present exemplary embodiment, an information processing program is stored in the ROM 102 or the storage 104.

The ROM 102 stores various programs and various types of data. The RAM 103 temporarily stores the program or the data as a working area. The storage 104 is configured by a hard disk drive (HDD) or a solid state drive (SSD), and stores various programs including an operating system and various types of data. A program of a printer driver is stored in the storage 104. The CPU 101 reads out the program of the printer driver from the storage 104 and executes the program to function as the printer driver.

The input and output interface 105 is an interface for communicating with each device mounted in the image forming system 10. The control unit 100 is connected to the charging roll power supply 120, the exposure device 64, the developing device 66, the primary transfer roll power supply 124, the motor group 126, and the density sensor 72 via the input and output interface 105.

An output value as a measurement value measured by the density sensor 72 is input to the control unit 100.

The charging roll power supply 120 applies a charging bias (that is, a charging voltage) to the charging roll 62. As a result, the photoreceptor 22 is charged.

The developing roll power supply 122 applies a developing voltage to the developing roll 66A. At the time of normal image formation, the developing voltage is applied to the developing roll 66A, so that a latent image of the photoreceptor 22 is developed with the toner, and a toner image is formed.

The primary transfer roll power supply 124 applies a primary transfer voltage to the primary transfer roll 34. At the time of normal image formation, the primary transfer voltage is applied to the primary transfer roll 34, so that the toner image on the surface of the photoreceptor 22 is primarily transferred onto the transfer belt 31.

The CPU 101 of the control unit 100 controls the charging roll power supply 120, the exposure device 64, the developing device 66, the primary transfer roll power supply 124, and the motor group 126 in the monochrome units 20Y, 20M, 20C, and 20K of the toner image forming unit 20.

The CPU 101 executes a nip width detection mode for detecting the nip width NW of the charging roll 62 to the photoreceptor 22. For example, at a timing of adjusting the density after the image forming system 10 has printed a determined number of sheets of 50 or more and 100 or less, the CPU 101 shifts from the normal image forming mode to the nip width detection mode.

The CPU 101 executes cleaning of the charging roll 62 in accordance with the detection result of the nip width NW of the charging roll 62 acquired in the nip width detection mode.

### Detection of Nip Width of Charging Roll

Next, a process for detecting the nip width NW of the charging roll 62 to the photoreceptor 22 will be described.

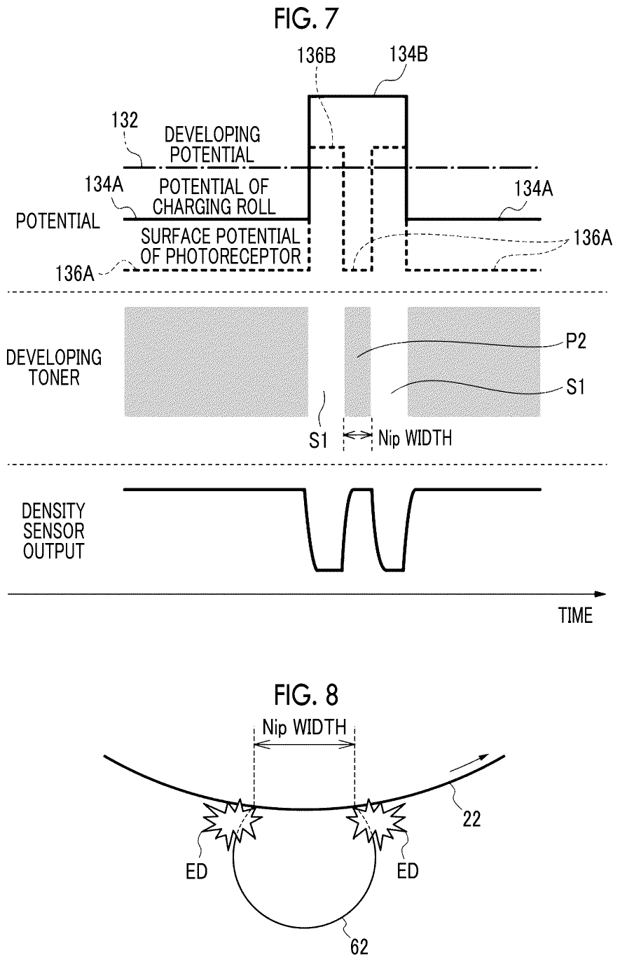

FIG. 7 shows the potential of each unit, the developing toner of the photoreceptor 22, and output of the density sensor 72 with respect to time when detecting the nip width NW of the charging roll 62 to the photoreceptor 22. As shown in FIG. 7, in the nip width detection mode, the CPU 101 sets a state in which the absolute value of the surface potential 136A of the photoreceptor 22 charged by the charging roll 62 is lower than the absolute value of the developing potential 132 of the developing device 66. For example, by making the absolute value of the potential (that is, the potential of the charging bias) 134A of the charging roll 62 lower than the absolute value of the developing potential 132, the absolute value of the surface potential 136A of the photoreceptor 22 is made lower than the absolute value of the developing potential 132 of the developing device 66.

As an example, the developing potential 132 of the developing device 66 is set to −500 V, and the surface potential 136A of the photoreceptor 22 is set to −400 V. As an example, the potential (that is, the potential of the charging bias) 134A of the charging roll 62 is set to −450 V. As a result, the absolute value (for example, 400 V) of the surface potential 136A of the photoreceptor 22 charged by the charging roll 62 is set to be lower than the absolute value (for example, 500 V) of the developing potential 132 of the developing device 66.

As an example, in the nip width detection mode, the absolute value of the potential 134A of the charging roll 62 is lowered without changing the developing potential 132 of the developing device 66 in the normal image forming mode. As a result, the absolute value of the surface potential 136A of the photoreceptor 22 charged by the charging roll 62 is set to be lower than the absolute value of the developing potential 132 of the developing device 66.

As shown in FIG. 7, the CPU 101 increases the absolute value of the potential 134B of the charging roll 62 with a rectangular wave such that the absolute value of the surface potential 136B of the photoreceptor 22 is higher than the absolute value of the developing potential 132 of the developing device 66 only for a determined set time. The set time is a time during which for instantaneous discharge occurs before and after the nip width NW of the charging roll 62 to the photoreceptor 22 and no discharge occurs at the center of the nip width NW.

As an example, the potential 134B of the charging roll 62 is set to a rectangular wave between −700 V and −800 V, and the surface potential 136B of the photoreceptor 22 is set to −600 V. As a result, the absolute value (for example, 600 V) of the surface potential 136B of the photoreceptor 22 is higher than the absolute value (for example, 500 V) of the developing potential 132 of the developing device 66.

As shown in FIG. 8, the charging roll 62 discharges before and after the nip width NW with the photoreceptor 22 (refer to a discharge state ED shown in FIG. 8). That is, discharge occurs in a space between the charging roll 62 and the photoreceptor 22 before and after the nip width NW. Therefore, as shown in FIG. 7, in a case where the absolute value of the potential 134B of the charging roll 62 is instantaneously increased, no discharge occurs within the nip width NW, and the absolute value of the surface potential 136A of the photoreceptor 22 does not increase. As an example, the surface potential 136A of the photoreceptor 22 in the portion where no discharge occurs is −400 V.

The set time for increasing the absolute value of the potential 134B of the charging roll 62 with a rectangular wave is set as follows, for example.

In a case where a diameter of the charging roll 62 is d [mm] and a rotation speed of the photoreceptor 22 is v [mm/sec], the set time denoted by t [ms] is expressed as t=d/v×2.92±5%.

As an example, in a case where a diameter d of the charging roll 62 is φ12 [mm] and a rotation speed v of the photoreceptor 22 is 175 [mm/sec], the set time t [ms] is 0.2±5% [ms].

The minimum value of the set time is a time required to reach the necessary potential 134B of the charging roll 62, and the maximum value of the set time is a time equal to or less than a time during which no non-discharging section remains in the nip width NW.

As an example, the minimum value of the set time is 0.15 [ms] which is the time required for the potential of the charging roll 62 to reach from −600 V to −900 V in a case where the rotation speed is 175 [mm/sec]. In addition, as an example, in a case where the minimum assumed nip width is 0.3 [mm], the maximum value of the set time is 0.3 [mm]/175 [mm/sec]=1.7 [ms]. For example, in the case of the diameter and the hardness of the charging roll 62 of the first exemplary embodiment, the minimum assumed nip width is 0.3 [mm]. In the rotation direction of the photoreceptor 22, in a case where a pre-discharge start position before and after the nip width NW comes to a post-discharge start position, there is no region where discharge is not performed.

A portion having a low absolute value of the surface potential 136A of the photoreceptor 22 is formed between a portion having a high absolute value of the surface potential 136B of the photoreceptor 22 by increasing the absolute value of the potential 134B of the charging roll 62 in a rectangular wave only for the above-described set time. The portion having a high absolute value of the surface potential 136B of the photoreceptor 22 and the portion having a low absolute value of the surface potential 136A of the photoreceptor 22 correspond to the “latent image” in the nip width detection mode. As a result, as shown in FIG. 7, the developing toner of the photoreceptor 22 developed by the developing device 66 is formed on a portion where the absolute value of the surface potential 136A of the photoreceptor 22 is lower than the absolute value of the developing potential 132. That is, since the toner has a negative polarity, the developing toner is formed on the portion of the surface potential 136A of the photoreceptor 22 where the surface potential 136A is −400 V. A position P2 where the fog toner (that is, the developing toner) is present during a state S1 in which the fog toner is present in a small amount in the rotation direction of the photoreceptor 22 corresponds to the nip width NW.

The fog toner (that is, the developing toner) on the surface of the photoreceptor 22 is primarily transferred onto the transfer belt 31, and the fog toner (that is, the developing toner) on the transfer belt 31 is measured by the density sensor 72. As shown in FIG. 7, the output of the density sensor 72 corresponds to the nip width NW. That is, a width of the position P2 where the fog toner (that is, the developing toner) is present during the state S1 where the fog toner is in a small amount is measured by the density sensor 72. The CPU 101 predicts the nip width NW of the charging roll 62 to the photoreceptor 22 according to a measurement value obtained by measuring the width of the position P2 where the toner (that is, the developing toner) is present by the density sensor 72. In present example, the density sensor 72 indirectly measures the fog toner (that is, the developing toner) on the surface of the photoreceptor 22 in order to primarily transfer the fog toner (that is, the developing toner) on the surface of the photoreceptor 22 onto the transfer belt 31.

As an example, the measurement of the fog toner (that is, the developing toner) on the transfer belt 31 by means of the density sensor 72 is performed about 10 times in succession, and the nip width NW is predicted from the average value.

The density sensor 72 is disposed at a position facing both end portions of the transfer belt 31 in the axial direction as described above. The measurement of the density of the toner by means of the density sensor 72 is performed only at a position corresponding to the end portion of the photoreceptor 22 in the axial direction. As a result, the CPU 101 predicts the nip width NW of the charging roll 62 at the end portion of the photoreceptor 22 in the axial direction according to the measurement value obtained by the density sensor 72.

### Cleaning of Charging Roll

Next, the cleaning of the charging roll 62 will be described.

In a case where the nip width NW of the charging roll 62 corresponding to the measurement value of the density sensor 72 is equal to or larger than a threshold value, the CPU 101 executes a cleaning mode for cleaning the charging roll 62. The cleaning mode is an example of a cleaning mode.

For example, the threshold value is set to 0.55. As described above, in a case where the nip width NW is 0.55 [mm] or more, the amount of the external additive adhering to the charging roll 62 is increased, and the fog toner of the photoreceptor 22 becomes in a large amount due to the charging failure (refer to FIG. 5). Therefore, by setting the threshold value to, for example, 0.55 and cleaning the charging roll 62, the amount of fog toner of the photoreceptor 22 can be reduced.

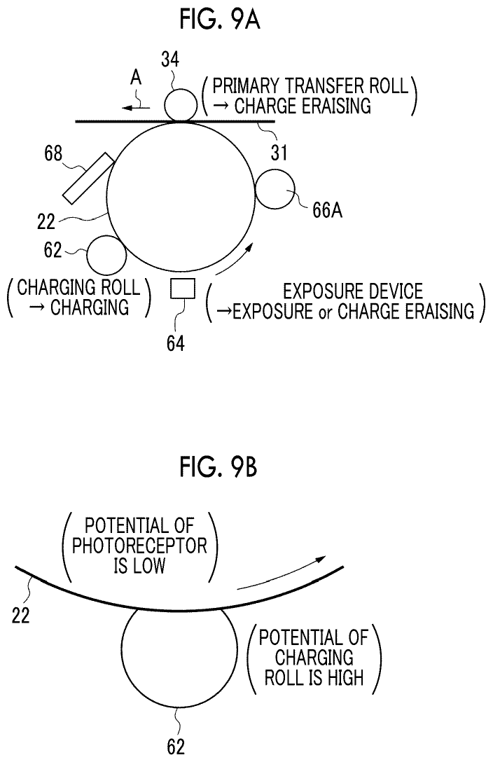

Here, before describing the cleaning mode, an example of normal image formation will be described. As shown in FIG. 9A, at the time of normal image formation, after the charge erasing of the primary transfer roll 34, the photoreceptor 22 is charged by the charging roll 62, and the exposure or the charge erasing of the photoreceptor 22 is performed by the exposure device 64. As a result, the latent image formed on the surface of the photoreceptor 22 is developed with the toner of the developing roll 66A. The toner image of the photoreceptor 22 is transferred onto the transfer belt 31 by the primary transfer roll 34.

As shown in FIG. 9B, at the time of normal image formation, an absolute value of the potential of the photoreceptor 22 is lowered, and an absolute value of the potential of the charging roll 62 is increased. Therefore, the adhesive substances such as the external additives adhering to the surface of the charging roll 62 are unlikely to move to the photoreceptor 22.

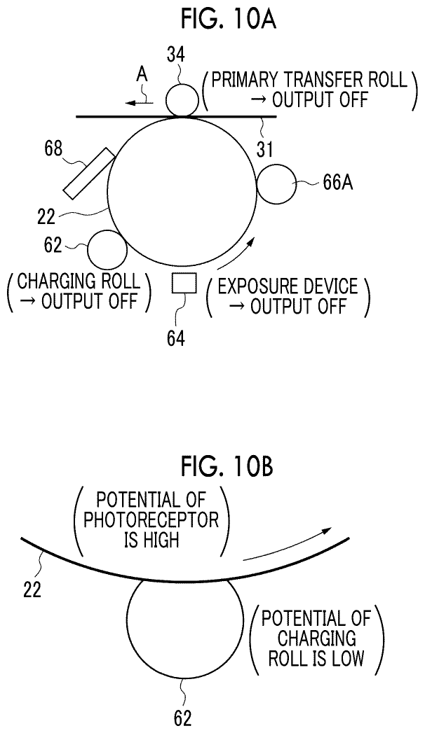

As shown in FIG. 10A, in the cleaning mode, a relationship between the potential of the photoreceptor 22 and the potential of the charging roll 62 is reversed. For example, the output of the primary transfer roll 34 is turned off, the output of the charging roll 62 is turned off, and the output of the exposure device 64 is turned off. As a result, as shown in FIG. 10B, an absolute value of the potential of the photoreceptor 22 is increased, and an absolute value of the potential of the charging roll 62 is lowered. As an example, the potential of the photoreceptor 22 is −600 V to −700 V. Therefore, the dirt (that is, the adhesive substances such as the external additives) on the surface of the charging roll 62 is transferred onto the photoreceptor 22. The dirt (that is, the adhesive substances such as the external additives) on the surface of the photoreceptor 22 is removed by the cleaning blade 68. The dirt (that is, the adhesive substances such as the external additives) on the surface of the photoreceptor 22 may be transferred onto the transfer belt 31 and removed by the cleaning blade 76.

In addition, in a case where the nip width NW of the charging roll 62 corresponding to the measurement value of the density sensor 72 is equal to or larger than the threshold value, the CPU 101 increases the absolute value of the potential of the charging roll 62 that charges the photoreceptor 22 in a case of the image formation, to be higher than the absolute value of the potential of the normal charging roll 62. By increasing the absolute value of the potential of the charging roll 62 to be higher than the absolute value of the potential of the normal charging roll 62, it is possible to widen the nip width NW of the charging roll 62, and to suppress the charging failure (that is, the fogging of the photoreceptor 22) caused by the progress of the dirt. For example, the absolute value of the potential of the charging roll 62 is set to be increased by +10 V with respect to the absolute value of the potential of the normal charging roll 62. As a result, the charging failure (that is, the fogging of the photoreceptor 22) caused by the unevenness of the nip width NW of the charging roll 62 in the axial direction is less likely to occur.

### Action of Image Forming System 10

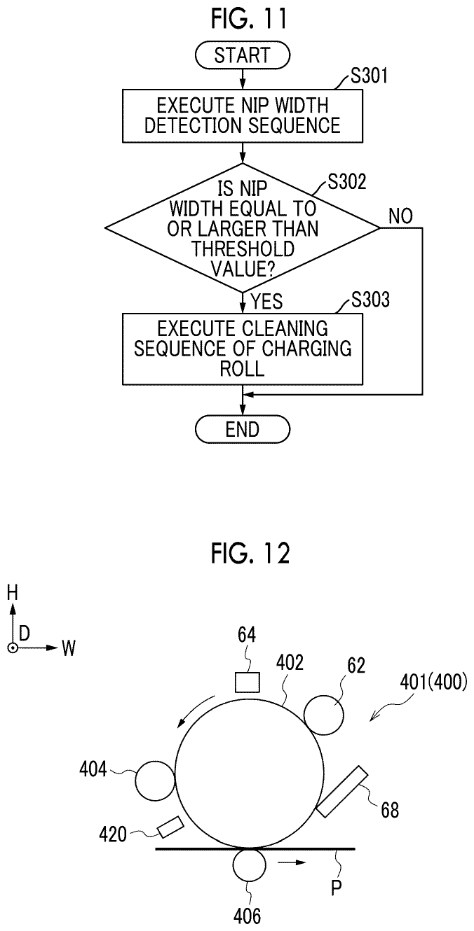

FIG. 11 is a flowchart showing the flow of information processing of the image forming system 10. In the image forming system 10, the CPU 101 reads out an information processing program from the ROM 102 or the storage 104, loads the program into the RAM 103, and executes the program, so that information processing is performed.

As shown in FIG. 11, the CPU 101 executes a detection sequence of the nip width NW of the charging roll 62 to the photoreceptor 22 (Step S301).

Specifically, the CPU 101 shifts from the normal image forming mode to the nip width detection mode after a determined number of sheets have been printed. As shown in FIG. 7, the CPU 101 sets a state in which the absolute value of the surface potential 136A of the photoreceptor 22 charged by the charging roll 62 is lower than the absolute value of the developing potential 132 of the developing device 66. In this state, the CPU 101 increases the absolute value of the potential 134B of the charging roll 62 with a rectangular wave such that the absolute value of the surface potential 136B of the photoreceptor 22 is higher than the absolute value of the developing potential 132 of the developing device 66 only for a determined set time. The set time is a time during which for instantaneous discharge occurs before and after the nip width NW of the charging roll 62 to the photoreceptor 22 and no discharge occurs at the center of the nip width NW. As a result, a portion having a low absolute value of the surface potential 136A of the photoreceptor 22 is formed between a portion having a high absolute value of the surface potential 136B of the photoreceptor 22.

As a result, the developing toner of the photoreceptor 22 developed by the developing device 66 is formed on a portion where the absolute value of the surface potential 136A of the photoreceptor 22 is lower than the absolute value of the developing potential 132 (refer to FIG. 7). The position P2 where the fog toner (that is, the developing toner) is present during a state S1 in which the fog toner is present in a small amount in the rotation direction of the photoreceptor 22 corresponds to the nip width NW.

Next, the fog toner (that is, the developing toner) on the surface of the photoreceptor 22 is primarily transferred onto the transfer belt 31, and the fog toner (that is, the developing toner) on the transfer belt 31 is measured by the density sensor 72. The CPU 101 predicts the nip width NW of the charging roll 62 to the photoreceptor 22 according to a measurement value obtained by measuring the width of the position P2 where the toner (that is, the developing toner) is present by the density sensor 72.

As shown in FIG. 11, the CPU 101 determines whether or not the nip width NW is equal to or larger than the threshold value (Step S302). As described above, the threshold value is 0.55, for example.

In a case where the nip width NW is equal to or larger than the threshold value (Step S302: YES), the CPU 101 executes the cleaning sequence of the charging roll 62 (Step S303).

Specifically, the CPU 101 shifts to the cleaning mode of the charging roll 62. As shown in FIG. 10A, for example, the output of the primary transfer roll 34 is turned off, the output of the charging roll 62 is turned off, and the output of the exposure device 64 is turned off. As a result, as shown in FIG. 10B, an absolute value of the potential of the photoreceptor 22 is increased, and an absolute value of the potential of the charging roll 62 is lowered. As a result, the dirt (that is, the adhesive substances such as the external additives) on the surface of the charging roll 62 is transferred onto the photoreceptor 22, and the dirt (that is, the adhesive substances such as the external additives) on the surface of the photoreceptor 22 is removed by the cleaning blade 68.

As shown in FIG. 11, in a case where the nip width NW is not equal to or larger than the threshold value (Step S302: NO), the CPU 101 ends the processing based on the information processing program of the image forming system 10.

As a result, the processing based on the information processing program of the image forming system 10 is ended.

It is possible to estimate the nip width NW of the charging roll 62 to the photoreceptor 22 in the image forming system 10 described above.

In addition, in the image forming system 10, in a case where a diameter of the charging roll 62 is d [mm] and a rotation speed of the photoreceptor 22 is v [mm/sec], the set time denoted by t [ms] is expressed as t=d/v×2.92±5%.

Therefore, in the image forming system 10, it is possible to form the position P2 where the fog toner corresponding to the nip width NW of the charging roll is present during a state in which the fog toner is in a small amount in the rotation direction of the photoreceptor 22 as compared with a case where the time t is longer than d/v×2.92±5% (refer to FIG. 7). In addition, in the image forming system 10, it is possible to form the position P2 where the fog toner corresponding to the nip width NW of the charging roll is present during a state in which the fog toner is in a small amount in the rotation direction of the photoreceptor 22 as compared with a case where the time t is shorter than d/v×2.92-5% (refer to FIG. 7).

In addition, in the image forming system 10, the minimum value of the set time is a time required to reach the necessary potential of the charging roll 62, and the maximum value of the set time is a time equal to or less than a time during which no non-discharging section remains in the nip width NW. Therefore, in the image forming system 10, it is possible to form the position P2 where the fog toner is present facing the nip width NW of the charging roll 62 during a state in which the fog toner is in a small amount in the rotation direction of the photoreceptor 22 by increasing the absolute value of the potential of the charging roll 62 only for the set time (refer to FIG. 7).

In addition, in the image forming system 10, the CPU 101 predicts the nip width NW of the charging roll 62 to the photoreceptor 22 according to the measurement value obtained by indirectly measuring the width of the position P2 where the fog toner is present during the state in which the fog toner is present in a small amount in the rotation direction of the photoreceptor 22. Therefore, in the image forming system 10, it is possible to estimate the nip width NW of the charging roll 62 to the photoreceptor 22 from the measurement value of the width of the position P2 where the fog toner is present.

In addition, the image forming system 10 includes the transfer belt 31 that transfers the toner on the surface of the photoreceptor 22 and a density sensor 72 that detects the density of the toner transferred onto the transfer belt 31. Therefore, in the image forming system 10, it is possible to measure the width of the fog toner during the state in which the fog toner is in a small amount by detecting the density of the toner transferred onto the transfer belt 31 by means of the density sensor 72.

In addition, in the image forming system 10, the measurement of the density of the toner is performed only at a position corresponding to the end portion of the photoreceptor 22 in the axial direction. Therefore, in the image forming system 10, it is easier to measure the width of the fog toner in the rotation direction of the photoreceptor 22 as compared with a case of measuring the density of the toner over the entire axial direction of the photoreceptor.

In addition, in a case where the nip width NW of the charging roll 62 corresponding to the measurement value of the density sensor 72 is equal to or larger than a threshold value, the CPU 101 executes a cleaning mode for cleaning the charging roll 62. Therefore, in the image forming system 10, it is possible to suppress the occurrence of the charging failure of the photoreceptor 22 due to the charging roll 62 as compared with a case where the nip width of the charging roll to the photoreceptor is not known.

In addition, the image forming system 10 includes the cleaning blade 68 that cleans the surface of the photoreceptor 22 on the downstream side of the transfer position where the toner image on the surface of the photoreceptor 22 is transferred onto the transfer belt 31 and on the upstream side of the charging roll 62. In the cleaning mode, the dirt of the charging roll 62 is transferred onto the photoreceptor 22, and the dirt on the photoreceptor 22 is removed by the cleaning blade 68. Therefore, in the image forming system 10, the dirt on the charging roll 62 may be removed by the cleaning blade 68 of the photoreceptor 22.

In addition, in a case where the nip width NW of the charging roll 62 corresponding to the measurement value of the density sensor 72 is equal to or larger than the threshold value, the CPU 101 increases the absolute value of the potential of the charging roll 62 that charges the photoreceptor 22 in a case of the image formation, to be higher than the absolute value of the potential of the normal charging roll 62. Therefore, in the image forming system 10, it is possible to suppress the occurrence of the charging failure of the photoreceptor 22 due to the charging roll 62 as compared with a case where the potential of the charging roll is constant at the time of image formation.

In addition, in the image forming system 10, the state in which the absolute value of the surface potential of the photoreceptor 22 charged by the charging roll is lower than the absolute value of the developing potential of the developing device 66 is obtained by lowering the absolute value of the potential of the charging roll 62 without changing the developing potential of the developing device 66. Therefore, in the image forming system 10, it is possible to suppress the cost of the output substrate of the developing device 66 as compared with a case where the developing potential of the developing device is changed.

In addition, in the image forming system 10, the charging roll 62 charges the photoreceptor 22 by adding an AC voltage to a DC voltage. Therefore, in the image forming system 10, it is possible to stabilize the surface potential of the photoreceptor 22 as compared with a case where the surface of the photoreceptor is charged with only the DC voltage.

In the first exemplary embodiment, the toner density is measured once by the density sensor 72, and the cleaning mode for cleaning the charging roll 62 is performed once according to the nip width NW of the charging roll 62 corresponding to the measurement value. However, the present disclosure is not limited to this configuration. The CPU 101 may increase the frequency of the cleaning mode for cleaning the charging roll 62 according to the nip width of the charging roll 62 corresponding to the measurement value of the density sensor 72. For example, the cleaning mode may be performed two or more times for every measurement of the width of the fog toner. As a result, in the image forming system 10, it is possible to suppress the occurrence of the charging failure of the photoreceptor 22 due to the charging roll 62 as compared with a case where the cleaning mode is performed once for every measurement of the width of the fog toner.

### Second Exemplary Embodiment

Next, an image forming system according to the second exemplary embodiment will be described. The identical components to the configurations of the first exemplary embodiment described above will be denoted the identical reference numerals and the description thereof will be omitted.

FIG. 12 shows a toner image forming unit 401 of an image forming system 400 according to the second exemplary embodiment. As shown in FIG. 12, the toner image forming unit 401 of the image forming system 400 includes a photoreceptor 402 that rotates in an arrow direction. The photoreceptor 402 is an example of an image carrier. In addition, the image forming system 400 includes the charging roll 62, the exposure device 64, a developing device 404, a transfer roll 406, and the cleaning blade 68 around the photoreceptor 402. Further, the image forming system 400 includes a density sensor 420. The developing device 404 is an example of a developing unit.

In the image forming system 400, the transfer roll 406 is disposed on a lower side of the photoreceptor 402 in the up-down direction. The transfer roll 406 directly transfers the toner image formed on the surface of the photoreceptor 402 onto the medium P transported between the photoreceptor 402 and the transfer roll 406. The medium Pis, for example, paper. The density sensor 420 is an example of a detection unit. The density sensor 420 is disposed between the developing device 404 and the transfer roll 406 in the rotation direction of the photoreceptor 402. The density sensor 420 detects the density of the toner on the surface of the photoreceptor 402. As an example, the density sensor 420 is disposed at a position facing both end portions of the photoreceptor 402 in the axial direction.

Other configurations of the image forming system 400 are the same as the configurations of the monochrome units of the toner image forming unit 20 of the image forming system 10 of the first exemplary embodiment. The image forming system 400 includes a nip width detection mode for detecting the nip width NW of the charging roll 62 to the photoreceptor 402. Further, the image forming system 400 includes a cleaning mode for cleaning the charging roll 62 according to the nip width NW.

In the image forming system 400 of the second exemplary embodiment, in addition to the effects of the same configurations as the image forming system 10 of the first exemplary embodiment, the following effects are obtained.

In the image forming system 400, the density of the toner on the surface of the photoreceptor 402 is directly detected by the density sensor 420. It is possible to measure the width of the fog toner during a state in which the fog toner on the surface of the photoreceptor 402 is in a small amount by means of the density sensor 420. In the image forming system 400, it is possible to predict the nip width NW of the charging roll 62 to the photoreceptor 402 according to the measurement value obtained by directly measuring the width of the fog toner.

### Supplementary Description

The image forming system according to the exemplary embodiment of the present disclosure is not limited to the image forming systems 10 and 400 described in the first and second exemplary embodiments, and various modifications can be made. In the first exemplary embodiment, the density sensor 72 is provided at a position facing the transfer belt 31 corresponding to both end portions of the photoreceptor 22 in the axial direction. However, the present disclosure is not limited to this configuration. For example, in a case where the profile of the charging roll 62 on the photoreceptor 22 is acquired, the nip width NW of the end portion of the charging roll 62 in the axial direction can be predicted, and thus the position of the density sensor 72 can be changed.

Similarly, in the second exemplary embodiment, the density sensor 420 is provided at a position facing both end portions of the photoreceptor 402 in the axial direction. However, the present disclosure is not limited to this configuration. For example, in a case where the profile of the charging roll 62 on the photoreceptor 402 is acquired, the nip width NW of the end portion of the charging roll 62 in the axial direction can be predicted, and thus the position of the density sensor 420 can be changed.

Further, in the first exemplary embodiment, the configuration of the coil spring 86 for pressing the charging roll 62 against the photoreceptor 22 can also be changed.

In addition, processing in the image forming systems 10 and 400 described above can also be realized by a dedicated hardware circuit. In this case, the processing may be executed by one piece of hardware, or may be executed by a plurality of pieces of hardware.

In addition, a program for operation of the image forming systems 10 and 400 may be provided by a computer-readable recording medium such as a Universal Serial Bus (USB) memory, a flexible disk, or a Compact Disc Read Only Memory (CD-ROM), or may be provided online via a network such as the Internet. In this case, the program recorded on the computer-readable recording medium is usually transferred to and stored in a memory, a storage, or the like. In addition, for example, the program may be provided as independent application software, or may be incorporated into software of each device as a function of the image forming systems 10 and 400.

Note that, although a specific exemplary embodiment of the present invention has been described in detail, the present invention is not limited to the exemplary embodiment and it is obvious to persons skilled in the art that other various exemplary embodiments are possible without departing from the scope of the present invention.

### Supplementary Note

Hereinafter, aspects of the present disclosure will be additionally described.

(((1)))

An image forming system comprising:
an image carrier that rotates;
a charging unit that rotates while being in contact with the image carrier and charges a surface of the image carrier by applying a charging bias;
a pressing member that presses the charging unit against the image carrier such that a nip width is generated;
a developing unit that develops a latent image formed on the surface of the image carrier with toner; and
at least one processor,
wherein the processor is configured to:
in a state in which an absolute value of a surface potential of the image carrier charged by the charging unit is lower than an absolute value of a developing potential of the developing unit, increase an absolute value of a potential of the charging unit with a rectangular wave only for a set time during which instantaneous discharge occurs before and after the nip width of the charging unit to the image carrier and no discharge occurs at a center of the nip width such that the absolute value of the surface potential of the image carrier is higher than the absolute value of the developing potential.
   (((2)))

The image forming system according to (((1))),
wherein the charging unit is a circular rotating body, and
in a case where a diameter of the charging unit is d [mm] and a rotation speed of the image carrier is v [mm/sec], the set time denoted by t [ms] is expressed as t=d/v×2.92±5%.
   (((3)))

The image forming system according to (((1))) or (((2))),
wherein a minimum value of the set time is a time required to reach a necessary potential of the charging unit, and a maximum value of the set time is a time equal to or less than a time during which no non-discharging section remains in the nip width.
   (((4)))

The image forming system according to any one of (((1))) to (((3))),
wherein the processor is configured to:
predict the nip width of the charging unit to the image carrier according to a measurement value obtained by directly or indirectly measuring a width of a position where fog toner is present during a state in which the fog toner is in a small amount in a rotation direction of the image carrier.
   (((5)))

The image forming system according to (((4))), further comprising:
an intermediate transfer body that transfers the toner on the surface of the image carrier; and
a density detection unit that detects a density of the toner transferred onto the intermediate transfer body.
   (((6)))

The image forming system according to (((4))), further comprising:
a detection unit that detects a density of the toner on the surface of the image carrier.
   (((7)))

The image forming system according to (((5))) or (((6))),
wherein the density of the toner is measured only at a position corresponding to an end portion of the image carrier in an axial direction.
   (((8)))

The image forming system according to (((4))),
wherein the processor is configured to:
in a case where the nip width of the charging unit corresponding to the measurement value is equal to or larger than a threshold value, execute a cleaning mode for cleaning the charging unit.
   (((9)))

The image forming system according to (((8))),
wherein the processor is configured to:
increase a frequency of the cleaning mode for cleaning the charging unit according to the nip width of the charging unit corresponding to the measurement value.
   (((10)))

The image forming system according to (((8))), further comprising:
a cleaning member that cleans the surface of the image carrier, the cleaning member being disposed on a downstream side of a transfer position where a toner image on the surface of the image carrier is transferred onto a medium and on an upstream side of the charging unit,
wherein in the cleaning mode, dirt of the charging unit is transferred onto the image carrier, and the cleaning member removes the dirt of the image carrier.
   (((11)))

The image forming system according to (((4))),
wherein the processor is configured to:
in a case where the nip width of the charging unit corresponding to the measurement value is equal to or larger than a threshold value, increase the absolute value of the potential of the charging unit that charges the image carrier at a time of image formation to be higher than an absolute value of the potential of the charging unit in a normal state.
   (((12)))

The image forming system according to any one of (((1))) to (((11))),
wherein the state in which the absolute value of the surface potential of the image carrier charged by the charging unit is lower than the absolute value of the developing potential of the developing unit is obtained by lowering the absolute value of the potential of the charging unit without changing the developing potential of the developing unit.
   (((13)))

The image forming system according to any one of (((1))) to (((12))),
wherein the charging unit charges the image carrier by adding an AC voltage to a DC voltage.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device). In the embodiments above, the term “processor” is broad enough to encompass one processor or plural processors in collaboration which are located physically apart from each other but may work cooperatively. The order of operations of the processor is not limited to one described in the embodiments above, and may be changed.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image forming system comprising:
an image carrier that rotates;
a charging unit that rotates while being in contact with the image carrier and charges a surface of the image carrier by applying a charging bias;
a pressing member that presses the charging unit against the image carrier such that a nip width is generated;
a developing unit that develops a latent image formed on the surface of the image carrier with toner; and
at least one processor,
wherein the processor is configured to:
in a state in which an absolute value of a surface potential of the image carrier charged by the charging unit is lower than an absolute value of a developing potential of the developing unit, increase an absolute value of a potential of the charging unit with a rectangular wave only for a set time during which instantaneous discharge occurs before and after the nip width of the charging unit to the image carrier and no discharge occurs at a center of the nip width such that the absolute value of the surface potential of the image carrier is higher than the absolute value of the developing potential.

2. The image forming system according to claim 1,
wherein the charging unit is a circular rotating body, and
in a case where a diameter of the charging unit is d [mm] and a rotation speed of the image carrier is v [mm/sec], the set time denoted by t [ms] is expressed as t=d/v×2.92±5%.

3. The image forming system according to claim 1,
wherein a minimum value of the set time is a time required to reach a necessary potential of the charging unit, and a maximum value of the set time is a time equal to or less than a time during which no non-discharging section remains in the nip width.

4. The image forming system according to claim 1,
wherein the processor is configured to:
predict the nip width of the charging unit to the image carrier according to a measurement value obtained by directly or indirectly measuring a width of a position where fog toner is present during a state in which the fog toner is in a small amount in a rotation direction of the image carrier.

5. The image forming system according to claim 4, further comprising:
an intermediate transfer body that transfers the toner on the surface of the image carrier; and
a density detection unit that detects a density of the toner transferred onto the intermediate transfer body.

6. The image forming system according to claim 4, further comprising:
a detection unit that detects a density of the toner on the surface of the image carrier.

7. The image forming system according to claim 5,
wherein the density of the toner is measured only at a position corresponding to an end portion of the image carrier in an axial direction.

8. The image forming system according to claim 6,
wherein the density of the toner is measured only at a position corresponding to an end portion of the image carrier in an axial direction.

9. The image forming system according to claim 4,
wherein the processor is configured to:
in a case where the nip width of the charging unit corresponding to the measurement value is equal to or larger than a threshold value, execute a cleaning mode for cleaning the charging unit.

10. The image forming system according to claim 9,
wherein the processor is configured to:
increase a frequency of the cleaning mode for cleaning the charging unit according to the nip width of the charging unit corresponding to the measurement value.

11. The image forming system according to claim 9, further comprising:
a cleaning member that cleans the surface of the image carrier, the cleaning member being disposed on a downstream side of a transfer position where a toner image on the surface of the image carrier is transferred onto a medium and on an upstream side of the charging unit,
wherein in the cleaning mode, dirt of the charging unit is transferred onto the image carrier, and the cleaning member removes the dirt of the image carrier.

12. The image forming system according to claim 4,
wherein the processor is configured to:
in a case where the nip width of the charging unit corresponding to the measurement value is equal to or larger than a threshold value, increase the absolute value of the potential of the charging unit that charges the image carrier at a time of image formation to be higher than an absolute value of the potential of the charging unit in a normal state.

13. The image forming system according to claim 1,
wherein the state in which the absolute value of the surface potential of the image carrier charged by the charging unit is lower than the absolute value of the developing potential of the developing unit is obtained by lowering the absolute value of the potential of the charging unit without changing the developing potential of the developing unit.

14. The image forming system according to claim 1,
wherein the charging unit charges the image carrier by adding an AC voltage to a DC voltage.

15. An image forming system comprising:
an image carrier that rotates;
a charging unit that rotates while being in contact with the image carrier and charges a surface of the image carrier by applying a charging bias;
a pressing member that presses the charging unit against the image carrier such that a nip width is generated;
a developing unit that develops a latent image formed on the surface of the image carrier with toner; and
at least one processor,
wherein the processor is configured to:
in a state in which an absolute value of a surface potential of the image carrier charged by the charging unit is lower than an absolute value of a developing potential of the developing unit, increase an absolute value of a potential of the charging unit with a rectangular wave only for a set time during which instantaneous discharge occurs before and after the nip width of the charging unit to the image carrier and no discharge occurs at a center of the nip width such that the absolute value of the surface potential of the image carrier is higher than the absolute value of the developing potential.
